(19) United States
(12) Patent Application Publication
(10) Pub. No.: US 2021/0039781 A1
(43) Pub. Date: Feb. 11, 2021

(54) DRONE PROXIMITY CHARGING

(71) Applicant: Intel Corporation, Santa Clara, CA (US)

(72) Inventors: Jiewen Jacques Yao, Shanghai (CN); Vincent J. Zimmer, Tacoma, WA (US); Rajesh Poornachandran, Portland, OR (US)

(21) Appl. No.: 17/040,601

(22) PCT Filed: May 21, 2018
(86) PCT No.: PCT/CN2018/087593

§ 371 Date: Sep. 23, 2020

(51) Int. Cl. B64C 39/02; G05D 1/10

(52) U.S. Cl. CPC B64C 39/024; B64C 2201/066; B64C 2201/146; G05D 1/101

(57) ABSTRACT

Disclosed herein is a charging drone. The charging drone can comprise a flight mechanism, a charging transmitter, a processor, and a memory. The processor can be in electrical communication with the flight mechanism and the charging transmitter. The memory can store instructions that, when executed by the processor, can cause the processor to perform operations. The operations can comprise receiving a charge request signal; transmitting a navigation signal to the flight mechanism; verifying credentials from an in-flight drone; and activing the charging transmitter. The charge request signal can include data associated with the in-flight drone. The navigation signal can include guidance data for guiding the charging drone to the in-flight drone. The credentials can be verified when the charging drone is proximate the in-flight drone. The charging transmitter can be activated upon verification of the credentials.

### TECHNICAL FIELD

Embodiments described generally herein relate to drone charging. Some embodiments relate to charging a first drone while in flight using a second drone.

### BACKGROUND

An unmanned aerial vehicle (UAV), commonly known as a drone, is an aircraft without a human pilot aboard. The size of drones can range from small hobby scale suitable for close range operation proximate a user to large scale systems capable of hauling large payloads over many miles. Drones can be used to provide services, perform military operations to reduce risk to human pilots, and as a hobby.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an example schematic for aerial drone recharging in accordance with some embodiments.

FIG. 2 illustrates an example schematic for a drone in accordance with some embodiments.

FIGS. 3A and 3B illustrate example methods in accordance with some embodiments.

### DETAILED DESCRIPTION

Drones can be powered by a battery supply. However, as drones are becoming more and more popular and use times increase, battery density is not scaling to keep up with these usages. Thus, the range and service time of drones can be limited. As disclosed herein, wireless charging can be used for charging drone batteries during flight. Consistent with embodiments, a charging drone can be used to charge an in-flight drone. In addition, the charging drone can charge more than one drone during a flight. For example, various in-flight drones can report a residual energy level. The residual energy can be used to determine a charging order such that the charging drone can charge the in-flight drone with the lowest reserve power before charging other in-flight drones.

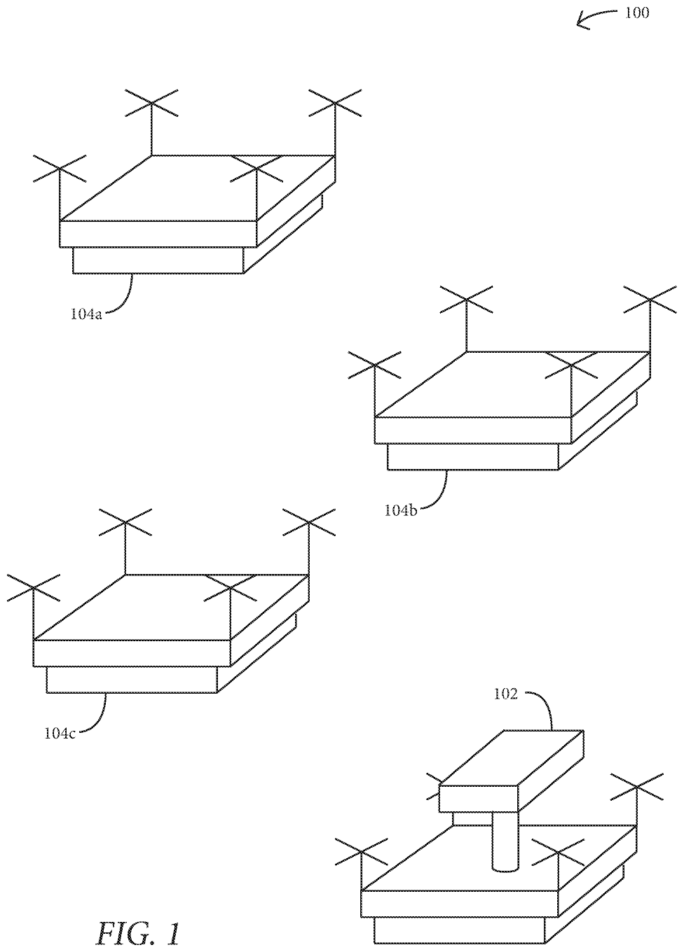

Turning now to the figures, FIG. 1 illustrates a schematic of a system 100 for aerial drone recharging. As shown in FIG. 1, the system 100 can include a charging drone 102 and a plurality of in-flight drones 104a, 104b, and 104c (collectively in-flight drones 104). During operation, the in-flight drones 104 can be airborne and performing a service. For example, the in-flight drones 104 can be providing aerial surveillance, acting as cell phone repeaters, etc.

The services being provided by the in-flight drones 104 can be sensitive to interruption. For instance, if the in-flight drones 104 are providing a communications relay, then downtime for recharging can result in loss of communications at critical times. To avoid downtime caused by a need to recharge the in-flight drones 104, the charging drone 102 can travel to each of the in-flight drones 104 and recharge them in flight. After recharging the in-flight drones 104, the charging drone 102 can return to a base for recharging or other maintenance.

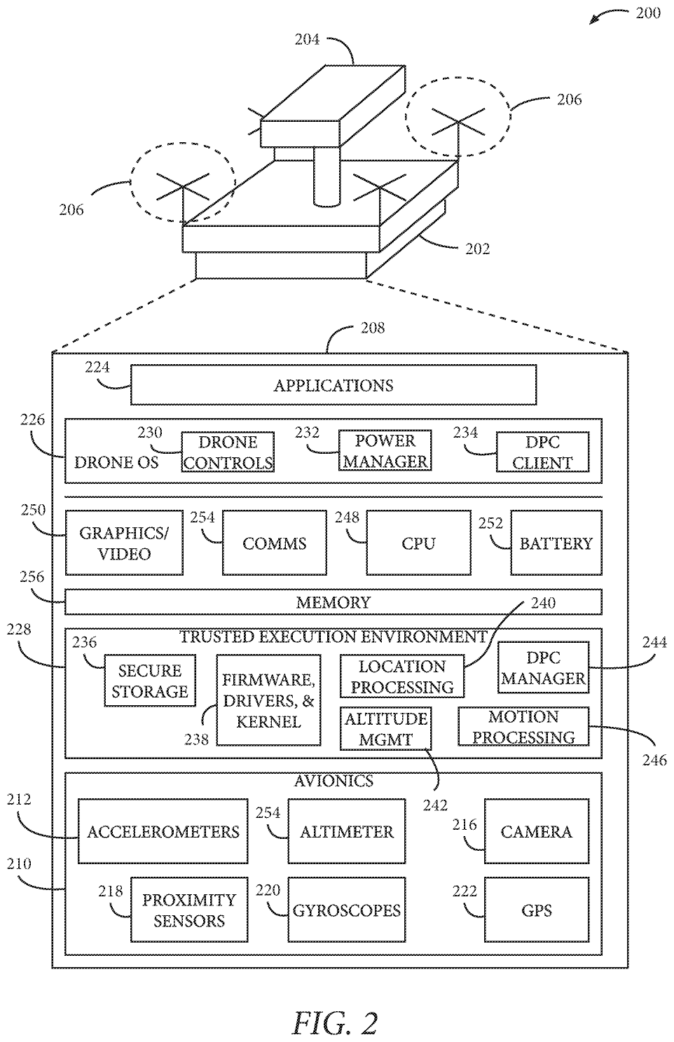

FIG. 2 shows an example schematic of a drone 200, such as charging drone 102 or in-flight drones 104. As shown in FIG. 2, the drone 200 can include an airframe 202, a charging transmitter 204, a flight mechanism 206, and computing environment 208. The airframe 202 can be made of made of polymers, metals, etc. and the other components of the drone 200 can be secured to the airframe 202.

The charging transmitter 204 can be a platform or other antenna system. For example, the charging transmitter 204 can be a platform that the in-flight drone 104 can land on during a recharging cycle. The charging transmitter 204 can allow for an inductive coupling of the in-flight drones 104 and the charging drone 102. Once one of the in-flight drones 104 and the charging drone 102 are inductively coupled, an electromagnetic field can be generated by the charging transmitter 204 in order to transfer energy to the in-flight drone 104. Because the charging drone 102 does not have to be physically connected to the in-flight drones 104 via a wire, it is possible that the charging drone 102 can charge more than one of the in-flight drones 104 simultaneously. For example, in-flight drone 104a and in-flight drone 104b can be proximate the charging drone 102 and thus be charged by the electromagnetic field generated by the charging drone 102.

The flight mechanism 206 can include mechanisms that can propel the drone 200 through the air. For example, the flight mechanism 206 can include propellers, rotors, turbofans, turboprops, etc. The flight mechanism 206 can operably interface with avionics 210. The avionics 210 can be part of the computing environment 208 (as shown in FIG. 2) or standalone components. For example, the avionics 210 can include accelerometers 212, an altimeter 214, a camera 216, proximity sensors 218, gyroscopes 220, and a global positioning system (GPS) receiver 222.

The various components of the avionics 210 can be standalone components or can be part of an autopilot system or other avionics package. For example, the altimeter 214 and GPS receiver 222 can be part of an autopilot system that include one or more axes of control. For instance, the autopilot system can be a two-axis autopilot that can maintain a preset course and hold a preset altitude. The avionics 210 can be used to control in-flight orientation of the drone 200. For example, the avionics 210 can be used to control orientation of the drone 200 about pitch, bank, and yaw axes while in flight. For instance, as the charging drone 102 approaches the in-flight drones 104, the charging drone 102 may need to maintain a particular bank angle in order to facilitate inductive coupling with the in-flight drones 104.

The camera 216 can allow an operator to pilot the drone 200. In addition, the avionics 210 can allow for autonomous flight. For example, as described herein, the drone 200 can determine a flight path to the in-flight drones 104 and navigate to the in-flight drones 104 without input from an operator.

The computing environment 208 can also include applications 224, a drone operating system (OS) 226, and a trusted execution environment (TEE) 228. The applications 224 can include services to be provided by the drone 200. For example, the applications 224 can include a surveillance program that can utilize the camera 216 to perform aerial surveillance. The applications 224 can include a communications program that can allow the drone 200 to act as a cellular repeater.

The drone OS 226 can include drone controls 230, a power management program 232, and a drone proximity charging (DPC) client 234. The drone controls 230 can interface with the avionics 210 to control flight of the drone 200. The drone controls 230 can also be a component of the avionics 210.

The power management program 232 can be used to manage the charging transmitter 204. In addition, the power management program 232 can be used to determine a power consumption of the drone 200 during a flight. For example, the charging drone 102 can need a certain amount of energy to fly to the in-flight drones 104 and return to base. In addition, the charging drone 102 can need to deliver a certain amount of energy to charge the in-flight drones 104. Thus, in order to complete a roundtrip recharging mission, the charging drone 102 may need a certain battery capacity. As an example, during a recharging mission, the charging drone 102 can determine that after charging a first drone (e.g., in-flight drone 102a), the charging drone 102 has enough energy reserves to fly back to base, but not enough energy reserves to charge a second drone. As a result, the power management program 232 can cause the charging drone 102 to terminate a mission and return to base.

The DPC client 234 can control the charging transmitter 204. For example, the DPC client 234 can include data regarding various charging protocols. During a recharging mission, the DPC client 234 can initialize an appropriate charging protocol for a given in-flight drone. The charging protocol can also include information regarding orientation of the charging drone 102 with regard to the in-flight drones 104, energy transfer rates, power settings for the charging transmitter 204, etc.

The TEE 228 can include secured storage 236, firmware, drivers and kernel 238, a location processing program 240, an altitude management program 242, a DPC manager 244, and a motion processing program 246. The components of the TEE 228 can operate in conjunction with other components of the drone 200. For example, the DPC manager 244 can operate in conjunction with the DPC client 234 during recharging of the in-flight drones 104. The altitude management program 242 can operate in conjunction with the avionics 210 during flight.

The TEE 228 can provide a secure area for storage of components used to authenticate communications between drones. For example, the TEE 228 can store SSL certificates or other security tokens described herein. The data stored in the TEE 228 can be read-only data such that during operation the data cannot be corrupted or otherwise altered by malware or viruses.

The computing environment 208 can include a central processing unit (CPU) 248, a video/graphics card 250, a battery 252, a communications interface 254, and a memory 256. The CPU 248 can be used to execute operations, such as those described herein. The video/graphics card 250 can be used to process images or video captured by the camera 216. The memory 256 can store data received by the drone 200 as well as programs and other software utilized by the drone 200. For example, the memory 256 can store instructions that, when executed by the CPU 248, cause the CPU 248 to perform operations such as those described herein.

The battery 252 can provide power to the drone 200. In addition, the battery 252 can be used to power the charging transmitter 204. While FIG. 2 shows a single battery, more than one battery can be utilized with drone 200. For example, a first battery can be used to power components of drone 200 such as computing environment 208 and flight mechanism 206. A second battery can be used to power the charging transmitter 204 and as storage for energy to be transferred to the in-flight drones 104. The communications interface 254 can include a wireless credential exchange. For example, the communications interface 254 can include a passive RF element that can be used for credential provision as described herein. In addition, the communications interface 254 can be a component of the TEE 228. As such the wireless credential exchange could be part of the TEE.

While FIG. 2 shows various components of the done 200, not all components shown in FIG. 2 are required. For example, in-flight drones 104 may not have a charging transmitter 204.

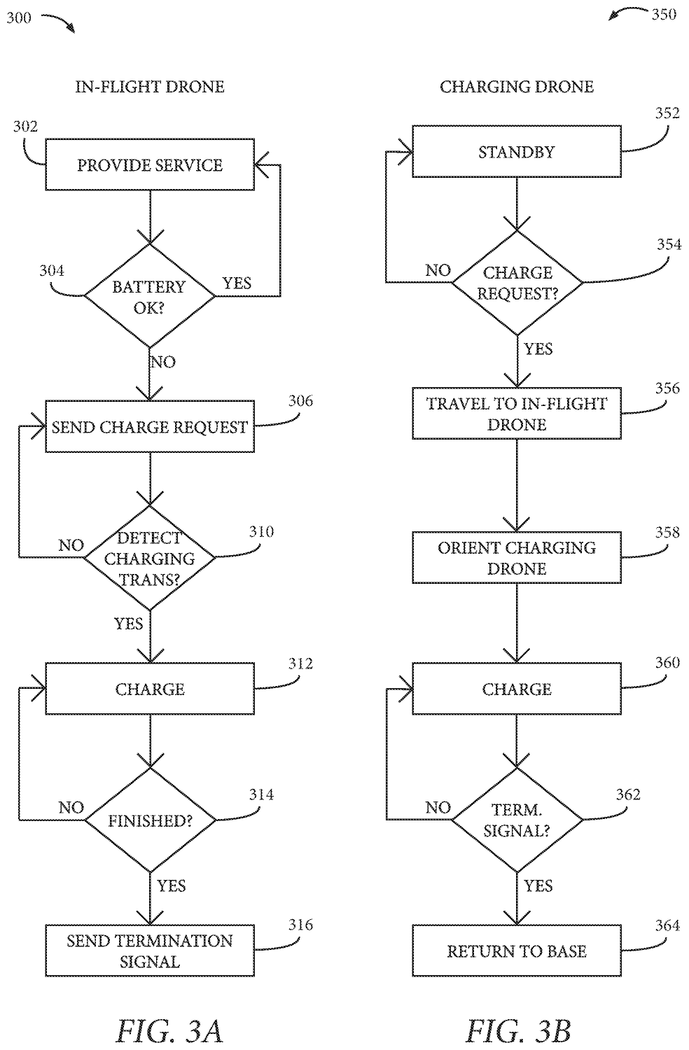

FIG. 3A illustrates an example method 300 for drone proximity charging from the perspective of an in-flight drone. The method 300 can begin at stage 302 with in-flight drones 104 providing a service. The service can be any service capable of being accomplished with via a drone. Non-limiting examples of the service include aerial surveillance, providing a communications relay, package delivery, etc.

From 302, the method 300 can proceed to decision block 304. At decision block 304, the in-flight drones 104 can determine if batteries, such as battery 252, have a residual energy level that is below a minimum residual energy level. For example, at decision block 304, the charging drones 104 can determine if they have a residual energy level below 25% of a full charge. If the residual energy level is above the minimum residual energy level, the in-flight drones 104 can continue providing the service as indicated in stage 302.

If the residual energy level is below the minimum residual energy level, the method can proceed to stage 306, where the in-flight drones 104 can send a charge request signal. The charge request signal can include data associated with the in-flight drone 104 that sent the charge request signal. For example, each of the in-flight drones 104 can be different from one another. For instance, each of the in-flight drones 104 can be of different makes and models, be manufactured by different manufacturers, etc.

The data associated with the in-flight drones 104 can include a physical orientation of the in-flight drones 104, a residual energy level of a power supply of the in-flight drones 104, a charging protocol for the in-flight drones 104, credentials of the in-flight drones 104, and a location of the in-flight drones 104.

The physical orientation of the in-flight drones 104 can be used by the charging drone 102 to determine if the charging drone 102 can position itself in a manner to charge the in-flight drones 104. For example, the charging drone 102 may need to position itself above the in-flight drones 104 for recharging. However, the in-flight drones 104 may utilize a rotor system that causes a downdraft above the in-flight drones 104. As a result, the charging drone 102 may need to be in a different orientation to charge the in-flight drones 104.

Each of the in-flight drones 104 may have different residual energy levels. For example, in-flight drone 104a may have a residual energy level of 30%, in-flight drone 104b may have a residual energy level of 35%, and in-flight drone 104c may have a residual energy level of 20%. As a result, the charging drone 102 can use the various residual energy levels to determine an order for charging the in-flight drones 104. For instance, given the above residual energy levels, the charging drone 102 can create a charging plan that charges in-flight drone 104c first, in-flight drone 104a second, and in-flight drone 104b last.

In addition, a policy can be used to determine a charging order. For example, in-flight drone 104a can have a higher priority mission (e.g., providing an encrypted communications relay) than in-flight drone 104b (e.g., providing video surveillance). As a result, even if in-flight drone 104b has a lower residual energy level, in-flight drone 104a may still be charged first.

Charging protocols can be used to determine if the charging drone 102 is capable of charging the in-flight drones 104. For example, the charging drone 102 may be capable of charging drones using charging protocols A, B, and D. However, in-flight drone 104c may only be capable of being charged using charging protocol C. As a result, the charging drone 102 may not be capable of recharging in-flight drone 104c. In-flight drone 104b may be capable of being recharged using charging protocols A and C. Thus, the charging drone 102 may be capable of recharging in-flight drone 104b. In addition, each of the charging protocols can have different efficiencies. As a result, the charging drone 102 can select the most efficient charging protocol to use for recharging the in-flight drones 104.

The credentials can be used to distinguish the various in-flight drones 104 from one another. For instance, the credentials of each of the in-flight drones 104 can include a digital certificate or other security token type information. The security information can be used to establish secure communications between the charging drone 102 and the in-flight drones 104. For example, in-flight drone 104a can utilize a digital certificate that can be signed and used to establish a secured socket layer (SSL) encrypted transmission between the charging drone 102 and the in-flight drone 104a. Use of the credentials can allow the charging drone 102 to identify the correct in-flight drone (e.g., in-flight drone 104a) from amongst the in-flight drones 104. In addition, the use of the credentials can help prevent interception of communications and potential spoofing of one drone by another.

From stage 306, the method 300 can proceed to decision block 310 where the in-flight drones 104 can detect the charging transmitter 204. Detecting the charging transmitter 204 can include exchanging the credentials. For example, the charging drone 102 can be proximate multiple in-flight drones 104 and determine which of the in-flight drones 104 needs to be charged due to the exchange of the credentials. For instance, the charging drone 102 can be proximate in-flight drone 104a and in-flight drone 104b. The exchange of credentials can indicate that in-flight drone 104b is to be charged.

From decision block 310, the method 300 can proceed to stage 312 where the in-flight drones 104 can receive charge from the charging drone 102. From stage 312, the method 300 can proceed to decision block 314, where the in-flight drone 104 can determine if its battery is fully charged or charged enough to complete the current mission. For example, at decision block 314 the in-flight drone 104 can monitor its residual energy level. Once the residual energy level reaches 100% or some other preset value, the method 300 can proceed to stage 316 where the in-flight drones 104 can transmit a termination signal. If the residual energy level has not reached 100% or the preset value, the method 300 can proceed to stage 312 where the in-flight drone 104 can continue to charge.

FIG. 3B illustrates an example method 350 for drone proximity charging from the perspective of the charging drone 102. The method 350 can begin at stage 352 with the charging drone 102 standing by. From stage 352, the method can proceed to decision block 354 where the charging drone 102 can determine if the charging request is received. If the charging request has not been received, the method 350 can proceed to stage 352 where the charging drone 102 continues to stand by.

If the charging request has been received, the method 350 can proceed to stage 356 where the charging drone 102 can travel to the in-flight drones 104. During stage 356, the charging drone 102 can receive a navigation signal. The navigation signal can be received by the charging drone 102 or generated by the charging drone 102. For example, the navigation signal can be received from a control system or other base station associated with the charging drone 102. In addition, the CPU 248 can generate the navigation signal. The navigation signal can be updated during the flight to the in-flight drones 104.

For example, during the flight to the in-flight drones 104, the charging drone 102 can receive GPS coordinates of the in-flight drones 104, which can be changing as the in-flight drones 104 move, as well as GPS coordinates of the charging drone 102. Using the various components of computing environment 208, the charging drone 102 can update its flight path to the in-flight drones 104.

In addition to GPS data, the charging drone 102 can receive airspace information. The airspace information can include identification of restricted airspace. For instance, the charging drone 102 may not be permitted to enter Class Bravo or Charlie airspace or military operation areas (MOAs). The flight path of the charging drone 102 may intersect Class Bravo or Charlie airspace. As a result, the charging drone 102 can determine a new flight path that can avoid the restricted airspace. The indications of restricted airspace can be part of a database that contains information found on standard aeronautical charts.

In addition, the charging drone 102 can receive notices to airmen (NOTAMs). The NOTAMs can identify temporary no-fly zones or other temporary flight restrictions. For example, a NOTAM can identify airspace that is temporarily a no-fly zone due to dignitaries with the airspace. In addition, NOTAMs can identify obstacles. For instance, a NOTAM can identify a tower crane temporarily erected during construction of a building. As a result of receiving the NOTAMs, the charging drone 102 can alter its flight path to avoid obstructions of other airspace restrictions.

The avionics 212 can also include an automatic dependent surveillance broadcast (ADS-B) transmitter, receiver, or transceiver. The charging drone 102 can send and receive ADS-B information. For example, the charging drone 102 can use an ADS-B transmitter to send traffic information to other aircraft flying in its vicinity. The traffic information can include the charging drone 102's heading, altitude, and airspeed. In addition, the charging drone 102 can receive ADS-B information from other aircraft. For example, the charging drone 102 can receive ADS-B information from the in-flight drones 104 or other aircraft. Using the ADS-B information from the in-flight drones 104 or other aircraft, the charging drone 102 can update its flight path to the in-flight drones 104 or to avoid other aircraft.

From stage 356, the method 350 can proceed to stage 358 where the charging drone 102 can orient itself to the in-flight drone 104. For example, Once the in-flight drones 104 detect the charging transmitter 204, the charging drone 102 can orient itself accordingly. For instance, the charging transmitter 204 can be a pad attached to the airframe 202. Once the in-flight drone 104 detects the charging pad 204, the charging drone 102 can orient itself such that the pad is horizontal and underneath the in-flight drone 104.

From stage 358, the method 350 can proceed to stage 360 where the charging drone 102 can charge the in-flight drone 104. For example, the in-flight drone 104 can land on the charging transmitter 204 hover proximate the charging transmitter 204 to be charged.

From stage 360, the method 350 can proceed to decision block 362 where the charging drone can determine if a termination signal has been received. For example, once an in-flight drone 104 has been charged, it can send a termination signal to the charging drone 104. If the termination signal has not been received, the method 350 can proceed to stage 360 where the charging drone 102 can continue to charge the in-flight drone 104. If the termination signal has been received, the method 350 can proceed to stage 364 where the charging drone 102 can return to a base station for recharging. In addition, the charging drone 102 can proceed to another in-flight drone 104 where the method 300 can be repeated.

### ADDITIONAL NOTES & EXAMPLES

Example 1 can include a charging drone. The charging drone can comprise a flight mechanism, a charging transmitter, a processor, and a memory. The processor can be in electrical communication with the flight mechanism and the charging transmitter. The memory can store instructions that, when executed by the processor, can cause the processor to perform operations. The operations can comprise receiving a charge request signal; transmitting a navigation signal to the flight mechanism; verifying credentials from an in-flight drone; and activing the charging transmitter. The charge request signal can include data associated with the in-flight drone. The navigation signal can include guidance data for guiding the charging drone to the in-flight drone. The credentials can be verified when the charging drone is proximate the in-flight drone. The charging transmitter can be activated upon verification of the credentials.

In Example 2, the charging drone of claim 1 can optionally include the data associated with the in-flight drone including a physical orientation of the in-flight drone.

In Example 3, the charging drone of any one of or any combination of Examples 1 and 2 can optionally include the data associated with the in-flight drone including a residual energy level of a power supply of the in-flight drone.

In Example 4, the charging drone of any one of or any combination of Examples 1-3 can optionally include the data associated with the in-flight drone including a charging protocol.

In Example 5, the charging drone of any one of or any combination of Examples 1-4 can optionally include the data associated with the in-flight drone including the credentials.

In Example 6, the charging drone of any one of or any combination of Examples 1-5 can optionally include the navigation signal including global positioning system (GPS) coordinates of the charging drone and the in-flight drone.

In Example 7, the charging drone of any one of or any combination of Examples 1-6 can optionally include the operations further comprising receiving airspace information.

In Example 8, the charging drone of Example 7 can optionally include the airspace information including an identification of restricted airspace.

In Example 9, the charging drone of any one of or any combination of Examples 1-8 can optionally include the operations further including defining a flight path to the in-flight drone.

In Example 10, the charging drone of Example 10 can optionally include defining the flight-path to the in-flight drone including avoiding restricted airspace.

In Example 11, the charging drone of any one of or any combination of Examples 1-10 can optionally include the operations further including determining a roundtrip power consumption.

In Example 12, the charging drone of any one of or any combination of Examples 1-11 can optionally include the flight mechanism including propellers and gyroscopes.

In Example 13, the charging drone of Example 12 can optionally include the operations further comprising utilizing feedback from the gyroscopes to cause the charging drone to hover proximate the in-flight drone.

In Example 14, the charging drone of Example 1-13 can optionally include the operations further comprising: receiving a traffic advisory; and updating a flight path to the in-flight drone in view of the traffic advisory.

In Example 15, the charging drone of Example 1-14 can optionally include the operations further comprising transmitting flight data, the flight data including altitude, speed, and position.

In Example 16, the charging drone of any one of or any combination of Examples 1-15 can optionally include receiving the charge request signal including receiving a plurality of charge request signals from a plurality of in-flight drones.

In Example 17, the charging drone of Example 16 can optionally include the operations further comprising: ranking the plurality of drones based on a residual energy level of each drone; and selecting the in-flight drone from the plurality of in-flight drones when the in-flight drone has a lowest residual energy level.

In Example 18, the charging drone of any one of or any combination of Examples 1-17 can optionally include the operations further comprising: ranking the plurality of drones based on a policy defining a priority for a plurality of in-flight drones; and selecting the in-flight drone from the plurality of in-flight drones based on the in-flight drone having a highest priority.

In Example 19, the charging drone of any one of or any combination of Examples 1-18 can optionally include the credentials being verified in a trusted execution environment.

Example 20 can include a charging drone. The charging drone can include: means for propelling the charging drone through air; means for receiving a charge request signal including data associated with an in-flight drone; means for navigating to the in-flight drone; means for verifying credentials of the in-flight drone when the charging drone is proximate the in-flight drone; and means for transmitting a charging signal to the in-flight drone upon verification of the credentials from the in-flight drone.

In Example 21, the charging drone of Example 20 can optionally include the data associated with the in-flight drone including a physical orientation of the in-flight drone.

In Example 22, the charging drone of any one of or any combination of Examples 20 and 21 can optionally include the data associated with the in-flight drone including a residual energy level of a power supply of the in-flight drone.

In Example 23, the charging drone of any one of or any combination of Examples 20-22 can optionally include the data associated with the in-flight drone including a charging protocol.

In Example 24, the charging drone of any one of or any combination of Examples 20-23 can optionally include the data associated with the in-flight drone including the credentials.

In Example 25, the charging drone of any one of or any combination of Examples 20-24 can optionally include the means for navigating to the in-flight drone including an autopilot capable of at least two-axis control.

In Example 26, the charging drone of any one of or any combination of Examples 20-25 can optionally include means for receiving airspace information.

In Example 27, the charging drone of Example 26 can optionally include the airspace information including an identification of restricted airspace.

In Example 28, the charging drone of any one of or any combination of Examples 20-27 can optionally include the means for navigating to the in-flight drone including means for defining a flight path to the in-flight drone.

In Example 29, the charging drone of Example 28 can optionally include the means for defining the flight-path to the in-flight drone including means for avoiding restricted airspace.

In Example 30, the charging drone of any one of or any combination of Examples 20-29 can optionally include means for determining a roundtrip power consumption.

In Example 31, the charging drone of any one of or any combination of Examples 20-31 can optionally include: means for receiving a traffic advisory; and means for updating a flight path to the in-flight drone in view of the traffic advisory.

In Example 32, the charging drone of any one of or any combination of Examples 20-31 can optionally include means for transmitting flight data, the flight data including altitude, speed, and position.

In Example 33, the charging drone of any one of or any combination of Examples 20-32 can optionally include the means for receiving the charge request signal including means for receiving a plurality of charge request signals from a plurality of in-flight drones.

In Example 34, the charging drone of Example 33 can optionally include: means for ranking the plurality of drones based on a residual energy level of each drone; and means for selecting the in-flight drone from the plurality of in-flight drones when the in-flight drone has a lowest residual energy level.

Example 35 can include a computer-readable medium storing instructions for charging an in-flight drone that, when executed by a processor, cause the processor to perform operations. The operations can comprise: receiving a charge request signal; transmitting a navigation signal to a flight mechanism; verifying credentials from an in-flight drone; and activing a charging transmitter. The charge request signal can include data associated with the in-flight drone. The navigation signal can include guidance data for guiding a charging drone to the in-flight drone. The credentials can be verified when the charging drone is proximate the in-flight drone. The charging transmitter can be active upon verification of the credentials from the in-flight drone.

In Example 36, the computer-readable medium of Example 35 can optionally include the data associated with the in-flight drone including a physical orientation of the in-flight drone.

In Example 37, the computer-readable medium of any one of or any combination of Examples 35 and 36 can optionally include the data associated with the in-flight drone including a residual energy level of a power supply of the in-flight drone.

In Example 38, the computer-readable medium of any one of or any combination of Examples 35-37 can optionally include the data associated with the in-flight drone including a charging protocol.

In Example 39, the computer-readable medium of any one of or any combination of Examples 35-38 can optionally include the data associated with the in-flight drone including the credentials.

In Example 40, the computer-readable medium of any one of or any combination of Examples 35-39 can optionally include the navigation signal including global positioning system (GPS) coordinates of the charging drone and the in-flight drone.

In Example 41, the computer-readable medium of any one of or any combination of Examples 35-40 can optionally include the operations further comprising receiving airspace information.

In Example 42, the computer-readable medium of Example 41 can optionally include the airspace information including an identification of restricted airspace.

In Example 43, the computer-readable medium of any one of or any combination of Example 35-42 can optionally include the operations further including defining a flight path to the in-flight drone.

In Example 44, the computer-readable medium of Example 43 can optionally include defining the flight-path to the in-flight drone including avoiding restricted airspace.

In Example 45, the computer-readable medium of any one of or any combination of Examples 35-44 can optionally include the operations further including determining a roundtrip power consumption.

In Example 46, the computer-readable medium of Examples 35-45 can optionally include the operations further comprising utilizing feedback from gyroscopes to cause the charging drone to hover proximate the in-flight drone.

In Example 47, the computer-readable medium of any one of or any combination of Examples 35-46 can optionally include the operations further comprising: receiving a traffic advisory; and updating a flight path to the in-flight drone in view of the traffic advisory.

In Example 48, the computer-readable medium of any one of or any combination of Examples 35-47 can optionally include the operations further comprising transmitting flight data, the flight data including altitude, speed, and position.

In Example 49, the computer-readable medium of any one of or any combination of Examples 35-51 can optionally include receiving the charge request signal including receiving a plurality of charge request signals from a plurality of in-flight drones.

In Example 50, the computer-readable medium of Example 49 can optionally include the operations further comprising: ranking the plurality of drones based on a residual energy level of each drone; and selecting the in-flight drone from the plurality of in-flight drones when the in-flight drone has a lowest residual energy level.

Example 51 can include a method of charging an in-flight drone. The method can comprise: receiving, at a charging drone, a charge request signal; transmitting, to a flight mechanism of the charging drone, a navigation signal; verifying, by the charging drone, credentials from an in-flight drone; and activing a charging transmitter. The charge request signal can include data associated with the in-flight drone. The navigation signal can include guidance data for guiding the charging drone to the in-flight drone. The credentials can be verified when the charging drone is proximate the in-flight drone. The charging transmitter can be activated upon verification of the credentials from the in-flight drone.

In Example 52, the method of Example 51 can optionally include the data associated with the in-flight drone including a physical orientation of the in-flight drone.

In Example 53, the method of any one of or any combination of Examples 51 and 52 can optionally include the data associated with the in-flight drone including a residual energy level of a power supply of the in-flight drone.

In Example 54, the method of any one of or any combination of Examples 51-53 can optionally include the data associated with the in-flight drone including a charging protocol.

In Example 55, the method of any one of or any combination of Examples 51-54 can optionally include the data associated with the in-flight drone including the credentials.

In Example 56, the method of any one of or any combination of Examples 51-55 can optionally include the navigation signal including global positioning system (GPS) coordinates of the charging drone and the in-flight drone.

In Example 57, the method of any one of or any combination of Examples 51-56 can optionally include receiving airspace information.

In Example 58, the method of Example 57 can optionally include the airspace information includes an identification of restricted airspace.

In Example 59, the method of any one of or any combination of Examples 51-58 can optionally include defining a flight path to the in-flight drone.

In Example 60, the method of claim 59 can optionally include defining the flight-path to the in-flight drone including avoiding restricted airspace.

In Example 61, the method of any one of or any combination of Examples 51-60 can optionally include determining a roundtrip power consumption.

In Example 62, the method of any one of or any combination of Examples 51-61 can optionally include utilizing feedback from gyroscopes to cause the charging drone to hover proximate the in-flight drone.

In Example 63, the method of any one of or any combination of Examples 51-62 can optionally include the operations further comprising: receiving a traffic advisory; and updating a flight path to the in-flight drone in view of the traffic advisory.

In Example 64, the method of any one of or any combination of Examples 51-63 can optionally include transmitting flight data, the flight data including altitude, speed, and position.

In Example 65, the method of any one of or any combination of Examples 51-64 can optionally include receiving the charge request signal including receiving a plurality of charge request signals from a plurality of in-flight drones.

In Example 66, the method of Example 65 can optionally include: ranking the plurality of drones based on a residual energy level of each drone; and selecting the in-flight drone from the plurality of in-flight drones when the in-flight drone has a lowest residual energy level.

Example 67 can include an in-flight drone. The in-flight drone can comprise: a battery, a flight mechanism, a processor, and a memory. The processor can be in electrical communication with the flight mechanism and the battery. The memory can store instructions that, when executed by the processor, can cause the processor to perform operations. The operations can comprise: transmitting a charging request signal, transmitting a navigation signal, transmitting credentials, and transmitting a termination request. The charge request signal can including data associated with the in-flight drone and can be transmitted to a charging drone. The navigation signal can include guidance data for guiding the charging drone to the in-flight drone. The credentials can be transmitted to the charging drone when the charging drone is proximate the in-flight drone. The termination request can be transmitted to the charging drone when a residual energy level of the battery is above a preset level.

In Example 68, the charging drone of Example 67 can optionally include the data associated with the in-flight drone including a physical orientation of the in-flight drone.

In Example 69, the charging drone of any one of or any combination of Examples 67 and 68 can optionally include the data associated with the in-flight drone including the residual energy level of the battery.

In Example 70, the charging drone of any one of or any combination of Examples 67-69 can optionally include the data associated with the in-flight drone including a charging protocol.

In Example 71, the charging drone of any one of or any combination of Examples 67-70 can optionally include the navigation signal including global positioning system (GPS) coordinates of the in-flight drone.

In Example 72, the charging drone of any one of or any combination of Examples 67-71 can optionally include the operations further comprising transmitting flight data, the flight data including altitude, speed, and position to the charging drone.

In Example 73, the charging drone of any one of or any combination of Examples 67-72 can optionally include the credentials being stored in a trusted execution environment.

Example 74 can include an in-flight drone. The in-flight drone can comprise: means for transmitting a charge request signal including data associated with the in-flight drone to a charging drone; means for transmitting a navigation signal including guidance data for guiding the charging drone to the in-flight drone; means for transmitting credentials to the charging drone when the charging drone is proximate the in-flight drone; and means for transmitting a termination request to the charging drone when a residual energy level of the battery is above a preset level.

In Example 75, the charging drone of Example 74 can optionally include the data associated with the in-flight drone including a physical orientation of the in-flight drone.

In Example 76, the charging drone of any one of or any combination of Examples 74 and 75 can optionally include the data associated with the in-flight drone including a residual energy level of a power supply of the in-flight drone.

In Example 77, the charging drone of any one of or any combination of Examples 74-76 can optionally include the data associated with the in-flight drone including a charging protocol.

In Example 78, the charging drone of any one of or any combination of Examples 74-77 can optionally include means for transmitting flight data, the flight data including altitude, speed, and position.

Example 79 can be a computer-readable medium. The computer-readable can store instructions for charging an in-flight drone that, when executed by a processor, can cause the processor to perform operations. The operations can comprise: transmitting a charge request signal, transmitting a navigation signal, transmitting credentials, and transmitting a termination request. The charge request signal can include data associated with the in-flight drone and can be transmitted to a charging drone. The navigation signal can include guidance data for guiding the charging drone to the in-flight drone. The credentials can be transmitted to the charging drone when the charging drone is proximate the in-flight drone. The termination request can be transmitted to the charging drone when a residual energy level of the battery is above a preset level.

In Example 80, the computer-readable medium of Example 79 can optionally include the data associated with the in-flight drone including a physical orientation of the in-flight drone.

In Example 81, the computer-readable medium of any one of or any combination of Examples 79 and 80 can optionally include the data associated with the in-flight drone including a residual energy level of a power supply of the in-flight drone.

In Example 82, the computer-readable medium of any one of or any combination of Examples 79-81 can optionally include the data associated with the in-flight drone including a charging protocol.

In Example 83, the computer-readable medium of any one of or any combination of Examples 79-82 can optionally include the navigation signal including global positioning system (GPS) coordinates of the charging drone and the in-flight drone.

In Example 84, the computer-readable medium of any one of or any combination of Examples 79-83 can optionally include the operations further comprising transmitting flight data, the flight data including altitude, speed, and position.

Example 85 can include a method for charging an in-flight drone. The method can comprise: transmitting, by an in-flight drone including a processor, a charge request signal including data associated with the in-flight drone to a charging drone, transmitting, by the in-flight drone, a navigation signal including guidance data for guiding the charging drone to the in-flight drone, transmitting, by the in-flight drone, credentials to the charging drone when the charging drone is proximate the in-flight drone, and transmitting, by the in-flight drone, a termination request to the charging drone when a residual energy level of the battery is above a preset level

In Example 86, the method of Example 85 can optionally include the data associated with the in-flight drone including a physical orientation of the in-flight drone.

In Example 87, the method of any one of or any combination of Examples 85 and 86 can optionally include the data associated with the in-flight drone including a residual energy level of a power supply of the in-flight drone.

In Example 88, the method of any one of or any combination of Examples 85-87 can optionally include the data associated with the in-flight drone including a charging protocol.

In Example 89, the method of any one of or any combination of Examples 85-88 can optionally include the navigation signal including global positioning system (GPS) coordinates of the charging drone and the in-flight drone.

Example 90 can include at least one machine-readable medium including instructions, which when executed by a machine, cause the machine to perform operations of any of the methods of Examples 51-66.

Example 91 can include an apparatus comprising means for performing any of the methods of Examples 51-66.

Example 92 can include at least one machine-readable medium including instructions, which when executed by a machine, cause the machine to perform operations of any of the methods of Examples 85-89.

Example 93 can include an apparatus comprising means for performing any of the methods of Examples 85-89.

As used herein, the term “module” is understood to encompass a tangible entity, be that an entity that is physically constructed, specifically configured (e.g., hardwired), or temporarily (e.g., transitorily) configured (e.g., programmed) to operate in a specified manner or to perform at least part of any operation described herein. Considering examples in which modules are temporarily configured, a module need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. The term “application,” or variants thereof, is used expansively herein to include routines, program modules, programs, components, and the like, and may be implemented on various system configurations, including single-processor or multiprocessor systems, microprocessor-based electronics, single-core or multi-core systems, combinations thereof, and the like. Thus, the term application may be used to refer to an embodiment of software or to hardware arranged to perform at least part of any operation described herein.

While a machine-readable medium may include a single medium, the term “machine-readable medium” may include a single medium or multiple media (e.g., a centralized or distributed database, and/or associated caches and servers).

The term “machine-readable medium” may include any medium that is capable of storing, encoding, or carrying instructions for execution by a machine (e.g., the CPU 248 or any other module) and that cause a machine to perform any one or more of the techniques of the present disclosure, or that is capable of storing, encoding or carrying data structures used by or associated with such instructions. In other words, the memory 256 can include instructions and can therefore be termed a machine-readable medium in the context of various embodiments. Other non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions may further be transmitted or received over a communications network using a transmission medium utilizing any one of a number of transfer protocols (e.g., frame relay, internet protocol (IP), TCP, user datagram protocol (UDP), hypertext transfer protocol (HTTP), etc.). Example communication networks may include a local area network (LAN), a wide area network (WAN), a packet data network (e.g., the Internet), mobile telephone networks ((e.g., channel access methods including Code Division Multiple Access (CDMA), Time-division multiple access (TDMA), Frequency-division multiple access (FDMA), and Orthogonal Frequency Division Multiple Access (OFDMA) and cellular networks such as Global System for Mobile Communications (GSM), Universal Mobile Telecommunications System (UMTS), CDMA 2000 1×* standards and Long Term Evolution (LTE)), Plain Old Telephone (POTS) networks, and wireless data networks (e.g., Institute of Electrical and Electronics Engineers (IEEE) 802 family of standards including IEEE 802.11 standards (WiFi), IEEE 802.16 standards (WiMax®) and others), peer-to-peer (P2P) networks, or other protocols now known or later developed.

The term “transmission medium” shall be taken to include any intangible medium that is capable of storing, encoding or carrying instructions for execution by hardware processing circuitry, and includes digital or analog communications signals or other intangible medium to facilitate communication of such software.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. However, the claims may not set forth features disclosed herein because embodiments may include a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1-21. (canceled)

22. A charging drone comprising:
a flight mechanism;
a charging transmitter;
a processor in electrical communication with the flight mechanism and the charging transmitter; and
a memory, storing instructions that, when executed by the processor, cause the processor to perform operations, the operations comprising:
receiving a charge request signal including data associated with an in-flight drone,
transmitting a navigation signal to the flight mechanism, the navigation signal including guidance data for guiding the charging drone to the in-flight drone,
verifying credentials from the in-flight drone using when the charging drone is proximate the in-flight drone, and
activing the charging transmitter upon verification of the credentials from the in-flight drone.

23. The charging drone of claim 22, wherein the data associated with the in-flight drone includes a residual energy level of a power supply of the in-flight drone.

24. The charging drone of claim 22, wherein the data associated with the in-flight drone includes a charging protocol.

25. The charging drone of claim 22, wherein the data associated with the in-flight drone includes the credentials.

26. The charging drone of claim 22, wherein the operations further include defining a flight path to the in-flight drone.

27. The charging drone of claim 22, wherein the operations further comprise utilizing feedback from gyroscopes to cause the charging drone to hover proximate the in-flight drone.

28. The charging drone of claim 22, wherein receiving the charge request signal includes receiving a plurality of charge request signals from a plurality of in-flight drones.

29. The charging drone of claim 28, wherein the operations further comprise:
ranking the plurality of drones based on a residual energy level of each drone; and
selecting the in-flight drone from the plurality of in-flight drones when the in-flight drone has a lowest residual energy level.

30. The charging drone of claim 22, wherein the operations further comprise:
ranking the plurality of drones based on a policy defining a priority for a plurality of in-flight drones; and
selecting the in-flight drone from the plurality of in-flight drones based on the in-flight drone having a highest priority.

31. The charging drone of claim 22, wherein the credentials are verified in a trusted execution environment.

32. A method of charging an in-flight drone, the method comprising:
receiving, at a charging drone, a charge request signal including data associated with an in-flight drone;
transmitting, to a flight mechanism of the charging drone, a navigation signal, the navigation signal including guidance data for guiding the charging drone to the in-flight drone;
verifying, by the charging drone, credentials from the in-flight drone when the charging drone is proximate the in-flight drone; and
activing a charging transmitter of the charging drone upon verification of the credentials from the in-flight drone.

33. The method of claim 32, wherein the data associated with the in-flight drone includes a residual energy level of a power supply of the in-flight drone.

34. The method of claim 32, wherein the data associated with the in-flight drone includes a charging protocol.

35. The method of claim 32, wherein the data associated with the in-flight drone includes the credentials.

36. The method of claim 32, wherein receiving the charge request signal includes receiving a plurality of charge request signals from a plurality of in-flight drones.

37. The method of claim 36, further comprising:
ranking the plurality of drones based on a residual energy level of each drone; and
selecting the in-flight drone from the plurality of in-flight drones when the in-flight drone has a lowest residual energy level.

38. A computer-readable medium storing instructions for charging an in-flight drone that, when executed by a processor, cause the processor to perform operations comprising:
receiving a charge request signal including data associated with an in-flight drone;
transmitting a navigation signal to a flight mechanism, the navigation signal including guidance data for guiding a charging drone to the in-flight drone;
verifying credentials from the in-flight drone when the charging drone is proximate the in-flight drone; and
activing a charging transmitter of the charging drone upon verification of the credentials from the in-flight drone.

39. The computer-readable medium of claim 38; wherein the data associated with the in-flight drone includes a residual energy level of a power supply of the in-flight drone.

40. The computer-readable medium of claim 38, wherein the data associated with the in-flight drone includes a charging protocol.

41. The computer-readable medium of claim 38, wherein the data associated with the in-flight drone includes the credentials.

42. The computer-readable medium of claim 38, wherein the operations further include defining a flight path to the in-flight drone.

43. The computer-readable medium of claim 38, wherein the operations further include determining a roundtrip power consumption.

44. The computer-readable medium of claim 38, wherein receiving the charge request signal includes receiving a plurality of charge request signals from a plurality of in-flight drones.

45. The computer-readable medium of claim 44, wherein the operations further comprise:
ranking the plurality of drones based on a residual energy level of each drone; and
selecting the in-flight drone from the plurality of in-flight drones when the in-flight drone has a lowest residual energy level.
